(19) United States
(12) Patent Application Publication
(10) Pub. No.: US 2025/0299658 A1
(43) Pub. Date: Sep. 25, 2025

(54) ELECTRONIC KEYBOARD INSTRUMENT

(71) Applicant: CASIO COMPUTER CO., LTD., Tokyo (JP)

(72) Inventors: Eita ONO, Tokyo (JP); Yoshihiko SATO, Tokyo (JP); Manabu OOTAKE, Tokyo (JP)

(73) Assignee: CASIO COMPUTER CO., LTD., Tokyo (JP)

(21) Appl. No.: 19/083,703

(22) Filed: Mar. 19, 2025

(30) Foreign Application Priority Data
Mar. 22, 2024 (JP) 2024-046016

(51) Int. Cl. G10H 1/34; G10G 5/00

(52) U.S. Cl. CPC G10H 1/344; G10G 5/00; G10H 2230/065

(57) ABSTRACT

An electronic keyboard instrument includes a casing of a rectangular shape having a bottom plate disposed to face a loading surface, and a keyboard provided in connection with the casing and having multiple keys aligned in a longitudinal direction of the casing, and the bottom plate includes multiple fixing legs protruding from the bottom plate towards the loading surface and configured to come into contact with the loading surface to thereby support the casing from below and a first adjustment leg disposed outside the fixing legs in an aligning direction of the multiple keys, and the first adjustment leg protrudes from the bottom plate towards the loading surface and is spaced apart from the loading surface.

### CROSS-REFERENCE TO RELATED APPLICATION

This application is based upon and claims the benefit of priority under 35 USC 119 of Japanese Patent Application No. 2024-046016 filed on Mar. 22, 2024, the entire disclosure of which, including the specification, claims, drawings and abstract, is incorporated herein by reference in its entirety.

### BACKGROUND

### Technical Field

The present disclosure relates to an electronic keyboard instrument.

### Description of the Related Art

An electronic keyboard instrument is often placed or loaded on a desk for use. For example, Japanese Patent Laid-Open No. 2002-215156 (JP-A-2002-215156) discloses an electronic keyboard instrument including four rubber legs provided on a bottom plate thereof. The rubber legs come into contact with a horizontal placement or loading surface to support a casing of the electronic keyboard instrument. When the casing flexes due to the player's key pressing, adjacent keys tend to be brought into contact with each other. In addition, the player may feel different key press feelings when he or she presses keys depending upon the positions of the keys so pressed. In either of the cases, the playability of the electronic keyboard instrument may deteriorate. Then, to deal with the flexure problems, it is general practice to increase the number of such legs to suppress the occurrence of flexure of the casing. On the other hand, while the casing can be supported properly by at least three to four legs, an excessive increase in the number of legs constitutes a cause for getting the casing wobbled easily. The suppression of the wobbling of the casing and the suppression of the flexure of the casing are in a trade-off relationship. While the flexure amount of the casing may differ to some extent depending on the material from which the casing is made, the flexure problem described above is generally easier to be caused as the longitudinal length of the casing becomes longer.

In electronic keyboard instruments, a configuration is often adopted in which four fixing legs are disposed individually in four corners of the bottom plate of a casing, which faces a loading surface so as to be in contact with the loading surface (to support the casing at all times), and two adjustment legs are disposed individually in front and back positions on a central portion of the bottom plate of the casing, the front and back positions being such that they are spaced apart from the loading surface when no key is depressed by a player. The adjustment legs are configured to be brought into contact with the loading surface to support the central portion of the casing when the casing is caused to flex due to the player's key pressing. In this way, the adjustment legs suppress an excessive flexure of the casing to thereby enhance the playability of the electronic keyboard instrument. In addition, the adjustment legs are not in contact with the loading surface when no flexure is generated in the casing, making it less likely for the casing to wobble. Thus, the combination of the fixing legs and adjustment legs aims to achieve both suppression of wobbling and suppression of flexure in the casing.

### SUMMARY

According to an aspect of the present disclosure, there is provided an electronic keyboard instrument including a casing of a rectangular shape having a bottom plate disposed to face a loading surface, and a keyboard provided in connection with the casing and having multiple keys aligned in a longitudinal direction of the casing, wherein the bottom plate comprises multiple fixing legs protruding from the bottom plate towards the loading surface and configured to come into contact with the loading surface to thereby support the casing from below and a first adjustment leg disposed outside the fixing legs in an aligning direction of the multiple keys, wherein the first adjustment leg protrudes from the bottom plate towards the loading surface and is spaced apart from the loading surface.

### BRIEF DESCRIPTION OF THE DRAWINGS

FIG. 1 is a perspective view of a keyboard model according to an embodiment of the present disclosure as viewed from above;

FIG. 2 is a perspective view of the keyboard model according to the embodiment as viewed from below;

FIG. 3 is a sectional view of the keyboard model according to the embodiment taken along a line III-III shown in FIG. 1;

FIG. 4A is a top view of the keyboard model according to the embodiment, FIG. 4B is a front view of the keyboard model according to the embodiment, and FIG. 4C is a bottom view of the keyboard model according to the embodiment; and

FIG. 5 is a partial front view of the keyboard model according to the embodiment showing a positional relationship among a fixing leg, adjustment legs and a loading surface.

### DESCRIPTION OF THE EMBODIMENT

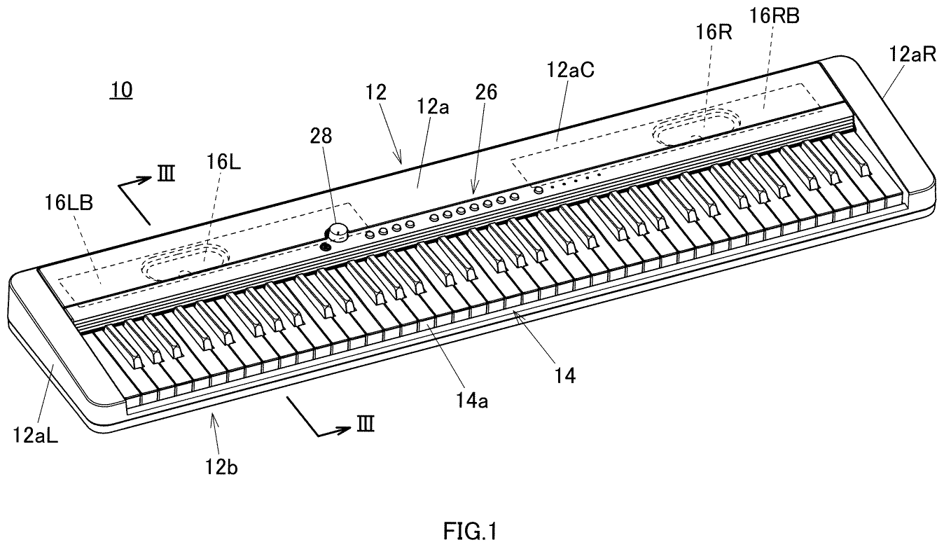

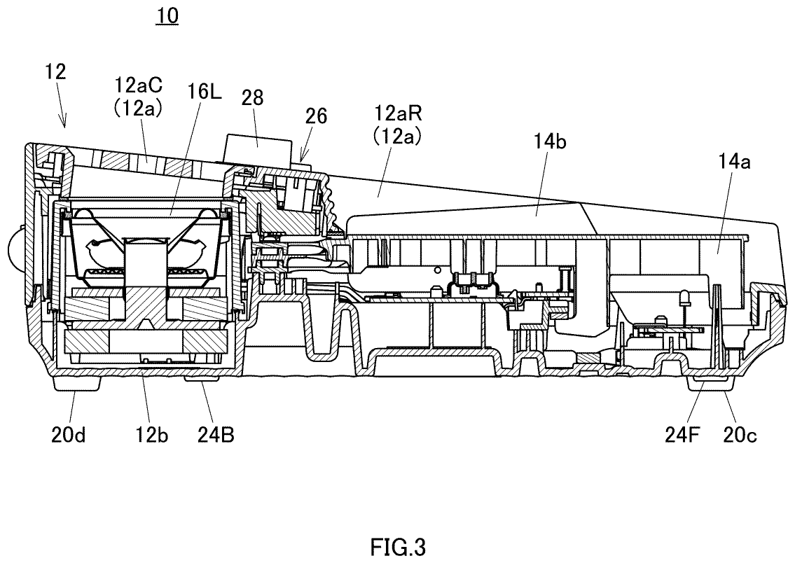

Hereinafter, referring to FIGS. 1 to 5, the structure of a keyboard model (an electronic keyboard instrument) 10 according to an embodiment of the present disclosure will be described. In the present embodiment, the keyboard model 10 will be described as including a keyboard 14 having 76 keys. The keyboard model 10 shown in FIG. 1 includes a casing 12 and the keyboard 14 having multiple keys which are aligned in a longitudinal direction of the casing 12. The key group 14C, located between (on the inside of) the sixth white key 14aL from the left and the sixth white key 14aR from the right, corresponds to the keyboard range of a traditional electronic keyboard instrument equipped with a total of 61 keys, including both white and black keys (hereinafter referred to as the “61-key model”). This key group represents a range that is relatively frequently played compared to the key group 14L located to the left (outside) of the sixth white key 14aL and the key group 14R located to the right (outside) of the sixth white key 14aR. In the following description, as shown in FIG. 1, a direction in which the keys on the keyboard 14 extend is defined as a front-back direction (a nearer side of FIG. 1 is referred to as a forward direction). The left-right direction and the front-back direction are at right angles to each other. A direction which is at right angles to the left-right direction and the front-back direction is defined as an up-down direction (an upper side in FIG. 1 is referred to as an upward direction).

As shown in FIG. 1, the casing 12 has a substantially rectangular shape of which a longitudinal direction follows the left-right direction. The casing 12 includes an upper cover 12a and a bottom plate 12b. Specifically speaking, the casing 12 is divided into the upper cover 12a and the bottom plate 12b. The upper cover 12a and the bottom plate 12b are each formed from a resin material. The casing 12 incorporates a circuit board (not shown) and the like in an interior thereof. As viewed from above, the upper cover 12a has a substantially U shape which opens forwards. The upper cover 12a has a left end unit 12aL, a right end unit 12aR and a central unit 12aC. The left end unit 12aL and the right end unit 12aR each have a substantially rectangular parallelepiped shape which extends in the front-back direction. The central unit 12aC has a substantially rectangular parallelepiped shape which extends in the left-right direction. Consequently, the left end unit 12aL, the right end unit 12aR and the central unit 12aC each have an upper surface, a left surface, a right surface, a front surface and a back surface. The left surface of the central unit 12aC connects to an upper end portion of the right surface of the left end unit 12aL. The right surface of the central unit 12aC connects to an upper end portion of the left surface of the right end portion 12aR. The upper surface of the central unit 12aC, the upper surface of the left end unit 12aL and the upper surface of the right end unit 12aR slightly slope downwards from the back to the front.

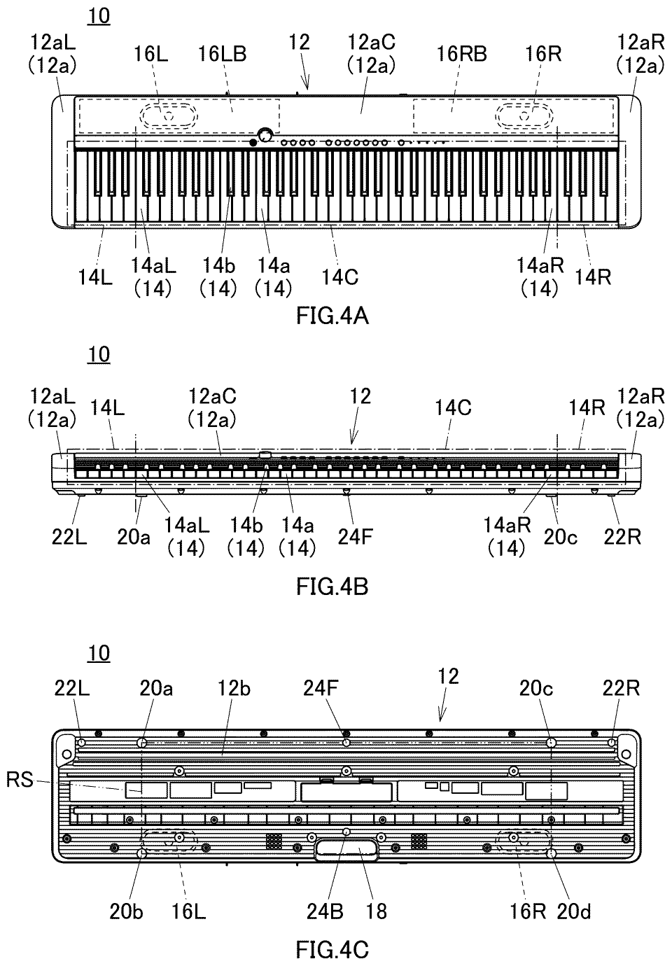

Various types of control switches 26 including a power switch are aligned in the left-right direction at a front central portion of the upper surface of the central unit 12aC. A volume control dial 28 is provided to the left of the control switches 26. A known key pressing mechanism is provided in a space defined between the keyboard 14 and the bottom plate 12b to realize a key press feeling and tone quality which are close to those of a real piano when the player strikes each key of the keyboard 14. In addition, loudspeaker enclosures 16LB, 16RB (refer to FIG. 1) are installed in a leftward position and a rightward position, respectively, in an interior of the central unit 12aC. The loudspeaker enclosures 16LB, 16RB each have a substantially rectangular shape of which a longitudinal direction follows the left-right direction. Loudspeakers (sound emitting devices) 16L, 16R are installed in the loudspeaker enclosures 16LB, 16RB, respectively. The keyboard model 10 has a relatively large number of keys, and hence, it is considered that the loudspeaker enclosures 16LB, 16RB also extend in the longitudinal direction. Then, when fixing legs are disposed in four corners of the casing 12, the distance between the loudspeakers 16L, 16R and the fixing legs increases. As a result, an excessive flexure is generated in the loudspeaker enclosures 16LB, 16RB due to the flexure of the casing 12, resulting in a fear that the loudspeakers 16L, 16R deform or fail. Then, the loudspeaker 16L is disposed in the vicinity of the fixing legs 20a, 20b, and the loudspeaker 16R is disposed in the vicinity of the fixing legs 20c, 20d. Specifically speaking, the loudspeaker 16L is disposed in a vicinity of the line segment that connects the fixing legs 20a and 20b, and the loudspeaker 16R is disposed in a vicinity of the line segment that connects the fixing legs 20c and 20d. To be more specific, as shown in FIG. 4C, in a plan view from above, the loudspeaker 16L partially overlaps the line segment that connects the fixing leg 20a and the fixing leg 20b together. In a plan view from above, the loudspeaker 16R partially overlaps the line segment that connects the fixing leg 20c and the fixing leg 20d together. The loudspeakers 16L, 16R are supported strongly and rigidly particularly in the front-back direction, making them less susceptible to the effects of flexure generated in the casing 12. The loudspeaker enclosures 16LB, 16RB are, for example, a sealed loudspeaker enclosure having a sealing unit. Loudspeaker enclosure grilles (not shown) are provided in a leftward position and a rightward position on the upper surface of the central unit 12aC in such a way as to correspond individually to the loudspeakers 16L, 16R.

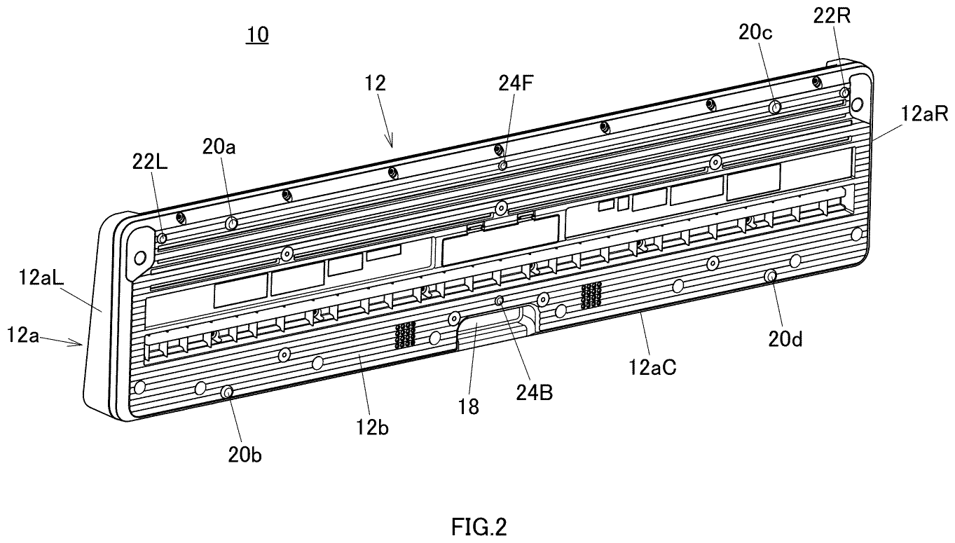

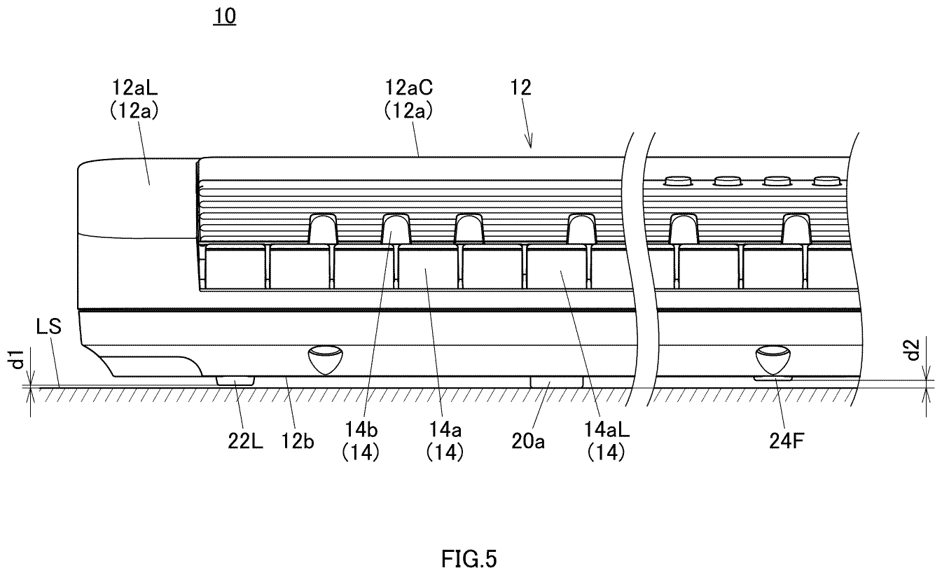

As shown in FIGS. 2, 4B and 4C, the bottom plate 12b is a plate-shaped component extending in the left-right direction and faces a loading surface LS (refer to FIG. 5) when the keyboard model 10 is placed on the loading surface LS. The bottom plate 12b includes a grip 18, the multiple fixing legs 20a, 20b, 20c, 20d, multiple first adjustment legs 22L, 22R and multiple second adjustment legs 24F, 24B. The grip 18 is positioned at a central back end portion of the bottom plate 12b. As viewed from below, the grip 18 has a substantially rectangular shape of which a longitudinal direction follows the left-right direction and is recessed.

The fixing legs 20a, 20b, 20c, 20d are a flat cylindrical component extending in the up-down direction. The fixing legs 20a, 20b, 20c, 20d protrude downwards (towards the loading surface LS) from the bottom plate 12b. Specifically speaking, the fixing legs 20a, 20b, 20c, 20d are disposed along the left-right direction on the bottom plate 12b in such a manner that the line segment that connects the fixing legs 20a, 20b, 20c, 20d together form a rectangle RS which extends in the longitudinal direction of the casing. In other words, the fixing legs 20a, 20b, 20c, 20d are provided at four positions on the bottom plate 12b, corresponding to the vertices of an imaginary rectangle RS extending in the longitudinal direction of the casing 12. The fixing leg 20a is positioned at a left front portion of the bottom plate 12b, and the fixing leg 20c is positioned at a right front portion of the bottom plate 12b. To be more specific, as viewed from above, the fixing leg 20a overlaps a front end portion of the sixth white key 14aL from the left, and as viewed from above, the fixing leg 20c overlaps a front end portion of the sixth white key 14aR from the right. Additionally, the fixing leg 20b is positioned at a left back portion of the bottom plate 12b, and the fixing leg 20d is positioned at a right back portion of the bottom plate 12b. In other words, the fixing legs 20a, 20b, 20c, 20d are not disposed below endmost keys (at a left end and a right end of the keyboard 14). When the fixing legs are disposed individually in the four corners of the casing 12 including the keyboard having the relatively large number of keys, a flexure amount at a central portion of the casing becomes excessively large, resulting in a risk that adjacent keys come into contact with each other and a uniform key press feeling deteriorates. Then, the fixing legs 20a, 20b, 20c, 20d are disposed so that a longest leg-to-leg distance is defined between them to such an extent that the flexure of the casing 12 remains in an allowable range.

As shown in FIG. 5, the fixing legs 20a, 20b, 20c, 20d come into contact with the loading surface LS at all times when the keyboard model 10 is placed on the loading surface LS, whereby the fixing legs support the casing 12 from below. An elastic material such as rubber is used for the fixing legs 20a, 20b, 20c, 20d. As a result, even in the event that the loading surface LS is irregular, the irregularity of the loading surface LS is mitigated as the fixing legs 20a, 20b, 20c, 20d deform elastically, whereby the casing 12 is prevented from getting wobbled.

The fixing leg 20b is positioned in the vicinity of the loudspeaker 16L, and the fixing leg 20d is positioned in the vicinity of the loudspeaker 16R. The fixing legs 20b, 20d are always in contact with the loading surface LS, making the portions of the casing 12 which lie in the vicinity of the fixing legs 20b, 20d less prone to flexing.

The first adjustment legs 22L, 22R are a flat cylindrical component extending in the up-down direction. The first adjustment legs 22L, 22R protrude downwards (towards the loading surface LS) from the bottom plate 12b and are spaced apart from the loading surface LS.

Specifically speaking, as viewed from below, the first adjustment legs 22L, 22R disposed symmetrically are positioned on the bottom plate 12b, outside the rectangle RS that extends in the left-right direction and is formed by the line segments connecting the fixing legs 20a, 20b, 20c, 20d together (in other words, outside the fixing legs 20a, 20b, 20c, 20d in the left-right direction). To be more specific, the first adjustment leg 22L is disposed below a front end portion of the endmost (the left end) key as viewed in the direction in which the endmost key extends. The first adjustment leg 22R is disposed below a front end portion of the endmost (the right end) key as viewed in the direction in which the endmost key extends. When the keys 14L, 14R, which are positioned outside the fixing legs 20a, 20b, 20c, 20d, are pressed, a force attempting to act upwards is applied to the keys 14C with the fixing legs acting as a fulcrum according to the leverage because the fixing legs are not disposed in the four corners of the casing 12. However, the generation of such a force attempting to act upwards can be suppressed by disposing the first adjustment legs 22L, 22R outside the fixing legs 20a, 20b, 20c, 20d, thereby making it possible to obtain a stable key press feeling.

The first adjustment legs 22L, 22R come into contact with the loading surface LS as the casing 12 flexes due to the pressing of the keyboard 14. The first adjustment legs 22L, 22R deform elastically when they come into contact with the loading surface LS and then support the casing 12 so as to suppress an excessive flexure of the casing 12. As shown in FIG. 2, the first adjustment legs 22L, 22R keep a first clearance (a clearance) d1, which is slight (for example, 0.3 mm), with respect to the loading surface LS when the keys on the keyboard 14 are not pressed (when the casing 12 does not flex). An elastic material such as rubber is used for the first adjustment legs 22L, 22R.

The second adjustment legs 24F, 24B are a flat cylindrical component extending in the up-down direction. The second adjustment legs 24F, protrude downwards (towards the loading surface LS) from the bottom plate 12b and are spaced apart from the loading surface LS. The second adjustment legs 24F, 24B come into contact with the loading surface LS as the casing 12 flexes due to the pressing of the keys on the keyboard 14. The second adjustment legs 24F, 24B deform elastically when they come into contact with the loading surface LS and then support the casing 12 so as to suppress an excessive flexure of the casing 12. As shown in FIG. 2, the second adjustment legs 24F, 24B keep a second clearance (a clearance) d2 (for example, 1.5 mm), which is larger than the first clearance d1, with respect to the loading surface LS when the keys on the keyboard 14 are not pressed (when the casing 12 does not flex). The reason that the second clearance d2 is larger than the first clearance d1 is that a flexure amount of the casing 12 which results when a key is pressed depends on a distance from a key pressing position to the nearest fixing leg. In other words, a flexure amount of the casing 12 becomes smaller when the keys located at the left end unit 12aL or the right end unit 12aR are pressed, compared with when the keys located at the central unit 12aC (in particular, the keys in the central portion) are pressed. In the case of the keyboard model (the electronic keyboard instrument) 10, a distance from the first adjustment leg 22L to the fixing leg 20a is smaller than a distance from the second adjustment leg 24F to the fixing leg 20a, and a flexure amount near the first adjustment leg 22L is smaller than a flexure amount near the second adjustment leg 24F. Thus, the second clearance d2 is set larger than the first clearance d1. An elastic material such as rubber is used for the second adjustment legs 24F, 24B.

The second adjustment legs 24F, 24B are disposed inside the rectangle RS (on the inner side of the fixing legs 20a, 20b, 20c, 20d in the key aligning direction). Specifically speaking, the second adjustment legs 24F, 24B are disposed at a central portion of the bottom plate 12b in the key aligning direction while being individually disposed on one side (a first side) and the other side (a second side) of the bottom plate 12b in the key extending direction. To be more specific, the second adjustment leg 24F is positioned on a front side of the central portion of the bottom plate 12b in the left-right direction. The second adjustment leg 24B is positioned on a back side of the central portion of the bottom plate 12b in the left-right direction. In other words, the second adjustment leg 24B is positioned in front of the grip 18.

In this way, the first adjustment leg 22L, the fixing leg 20a, the second adjustment leg 24F, the fixing leg 20C and the first adjustment leg 22R are disposed sequentially in this order from the left on a front portion of the bottom plate 12b. The fixing leg 20b, the second adjustment leg 24B and the fixing leg 20d are disposed sequentially in this order from the left on a back portion of the bottom plate 12b. Here, the fixing legs 20a, 20b, 20c, 20d, the first adjustment legs 22L, 22R and the second adjustment legs 24F, 24B have the same height dimension as constituent components, but their heights differ when those legs are disposed on the bottom plate 12b. On the other hand, when the fixing legs 20a, 20b, 20c, 20d, the first adjustment legs 22L, 22R and the second adjustment legs 24F, 24B have different height dimensions as constituent components (when the height dimension of the first adjustment legs 22L, 22R and the second adjustment legs 24F, 24B is shorter than the height dimension of the fixing legs 20a, 20b, 20c, 20d), the material cost can be reduced.

The keyboard 14 is disposed in an area in the casing 12 which is surrounded by the left end unit 12aL, the right end unit 12aR and the central unit 12aC, and the multiple keys are aligned in the left-right direction on the keyboard 14. In other words, the multiple keys on the keyboard 14 are aligned in the left-right direction in front of the central unit 12aC. When the keyboard 14 has, for example, 76 keys, these 76 keys are made up of 45 white keys 14a and 31 black keys.

Here, the effects of the keyboard model 10 of the present disclosure will be explained in comparison with its problem. Also, in an electronic keyboard instrument including a keyboard having a relatively large number of keys, as with the conventional model, it is considered that fixing legs are disposed individually in four corners of a bottom plate of a casing, while adjustment legs are disposed at a central portion of the bottom plate in order not only to support the casing uniformly but also to suppress the flexure of the casing. However, in the electronic keyboard instrument having such a large number of keys, a left-right direction (a longitudinal direction) in which the keys are aligned in the keyboard becomes longer than that of the conventional keyboard model including the keyboard having the relatively small number of keys. Thus, a central portion of the casing of the electronic keyboard instrument having the longer left-right direction tends to easily flex more than a central portion of the casing of the conventional keyboard model including the keyboard having the relatively small number of keys. In other words, a flexure amount at the central portion of the casing of the longitudinally long keyboard instrument tends to become larger, compared with a flexure amount at the central portion of the casing of the conventional longitudinally short keyboard model. As a result, there is caused a problem in that adjacent keys in the keyboard come into contact with each other due to a large flexure amount at the central portion of the casing even though the fixing legs are disposed individually in the four corners of the bottom plate of the casing.

To be more specific, when the fixing legs are disposed individually in the four corners of the keyboard model 10 while disposing the adjustment legs between these fixing legs, the amount of flexure of the casing 12 becomes large, resulting in a risk that the adjacent keys come into contact with each other. That is, the suppression of flexure is limited with the configuration in which the fixing legs are disposed individually in the four corners of the casing 12 while disposing the adjustment legs between the fixing legs. Although it is considered that the distance between the central adjustment legs and the loading surface is reduced to suppress the flexure amount, when the total number of keys on the keyboard becomes large to some extent, the distance between the adjustment legs and the loading surface has to be reduced excessively as the flexure amount increases, resulting in a similar situation to a situation in which the number of fixing legs disposed at the central portion is gradually increased, and hence, the problem of wobbling has not been able to be solved after all. To cope with this problem, with the keyboard model 10 according to the present disclosure, the fixing legs 20a, 20b, 20c, 20d are disposed so that a longest leg-to-leg distance is defined between them to such an extent that the flexure of the casing 12 remains in an allowable range, and the first adjustment legs 22L, 22R are disposed outside the fixing legs 20a, 20b, 20c, 20d. This suppresses the wobbling and flexure which will otherwise be generated in the casing 12.

With the keyboard model 10 of the present disclosure, compared with a case in which there are provided five or more fixing legs configured to be in contact with the loading surface LS at all times, the wobbling that will be generated in the casing 12 can be suppressed with the four fixing legs 20a, 20b, 20c, 20d while suppressing the material cost. In addition, the second adjustment legs 24F, 24B suppress an excessive flexure that will otherwise be generated in the casing 12 due to the pressing of the keys 14C. As a result, with the keyboard model 10 of the present disclosure, even though the casing 12 includes the keyboard 14 having the keys 14C which are pressed relatively more frequently, the casing 12 is supported effectively when the keys are pressed, whereby the same level of playability as the 61-key model can be provided.

In addition, with the keyboard model 10 of the present disclosure, the first adjustment legs 22L, 22R suppress an excessive flexure that will otherwise be generated in the casing 12 due to the pressing of the keys 14L, 14R. Further, the adjustment legs (the first adjustment leg 22L, the second adjustment leg 24B) and the fixing legs (the fixing leg 20a, the fixing leg 20c) are disposed alternately along the left-right direction at the front portion of the bottom plate 12b. The adjustment leg (the second adjustment leg 24B) and the fixing legs (the fixing leg 20b, the fixing leg 20d) are disposed alternately along the left-right direction at the back portion of the bottom plate 12b. In this way, the excessive flexure that will be generated in the casing 12 is suppressed effectively by disposing the first adjustment legs 22L, 22R and the second adjustment legs 24F, 24B between the fixing legs 20a, 20b, 20c, 20d which come into contact with the loading surface LS. Furthermore, the number of adjustment legs can be reduced to a minimum number because the first adjustment legs 22L, 22R effectively suppress the flexure that will be generated in the casing 12, thereby making it possible to reduce the production cost.

With the keyboard model 10 of the present disclosure, the first clearance dl defined between the first adjustment legs 22L, 22R and the loading surface LS when the casing 12 does not flex (when the keys 14L, 14R are not pressed) is smaller than the second clearance d2 defined between the second adjustment legs 24F, 24B and the loading surface LS when the casing 12 does not flexes. According to this configuration, the flexure generated in the casing 12 due to the pressing of the keys is made uniform because the keys at the central portion of the keyboard 14 are pressed relatively more frequently than the keys at the end portions of the keyboard 14. This enables the player to obtain a uniform key press feeling.

In general, the loudspeakers 16L, 16R are disposed in the vicinity of the left and right ends of the casing in many cases in order to realize a three-dimensional sound effect or to emit sounds in which low-frequency sounds and high-frequency sounds are allocated in a good balance. Here, the speakers 16L and 16R may be affected by the flexure of the casing 12, potentially causing the speakers 16L and 16R themselves to deform or become damaged. Additionally, the clearance between the speakers 16L and 16R and other components may widen, leading to the risk of the speakers 16L and 16R becoming detached. Thus, the distances between the fixing legs and the loudspeakers 16L, 16R are increased when the fixing legs are simply disposed in the four corners of the casing, which results in the problem in that the loudspeakers 16L, 16R are largely affected by the flexure in the casing. In contrast with this, with the keyboard model 10 of the present disclosure, the loudspeakers 16L, 16R are supported strongly and rigidly by being disposed in the vicinity of the fixing legs 20a, 20b, 20c, 20d. Thus, the loudspeakers 16L 16R are less likely to be affected by the flexure of the casing 12, whereby the loudspeakers 16L, 16R are prevented from deforming or failing.

Here, the multiple keys tend to be pressed all together at one time with the left hand of the player used for backing or accompaniment, and as this occurs, the multiple keys tend to be pressed strongly. In addition, the keys at the end portion are used more frequently. To cope with these situations, as a modified example of the embodiment that has been described heretofore, the clearance defined between the left first adjustment leg 22L and the loading surface LS may be set larger than the clearance defined between the right first adjustment leg 22R and the loading surface LS.

Thus, the embodiments that have been described heretofore are presented as the examples, and hence, there is no intention to limit the scope of the present disclosure by the embodiments. The novel embodiments can be carried out in other various forms, and various omissions, replacements and modifications can be made thereto without departing from the spirit and scope of the present disclosure. The present disclosure may be applied to, for example, an electronic keyboard instrument including a keyboard having 61 or 88 keys. These embodiments and modified examples thereof are included in the scope and gist of the present disclosure and are also included in the scope of inventions claimed for patent under claims below and their equivalents.

What is claimed is:

1. An electronic keyboard instrument comprising:
a casing of a rectangular shape having a bottom plate disposed to face a loading surface; and
a keyboard provided in connection with the casing and having multiple keys aligned in a longitudinal direction of the casing,
wherein the bottom plate comprises multiple fixing legs protruding from the bottom plate towards the loading surface and configured to come into contact with the loading surface to thereby support the casing from below and a first adjustment leg disposed outside the fixing legs in an aligning direction of the multiple keys, wherein the first adjustment leg protrudes from the bottom plate towards the loading surface and is spaced apart from the loading surface.

2. The electronic keyboard instrument according to claim 1,
wherein the fixing legs are provided at four positions on the bottom plate, corresponding to vertices of an imaginary rectangle extending in the longitudinal direction of the casing,
wherein each of the fixing legs is not disposed below an endmost key among the multiple keys, and
wherein the first adjustment leg is disposed below the endmost key.

3. The electronic keyboard instrument according to claim 1,
wherein the first adjustment leg is disposed on a first side in an extending direction of the multiple keys.

4. The electronic keyboard instrument according to claim 3,
wherein the first adjustment leg is disposed on a front side in the extending direction of the multiple keys.

5. The electronic keyboard instrument according to claim 1,
wherein the bottom plate comprises a second adjustment leg disposed inside the fixing legs in the aligning direction, wherein the second adjustment leg protrudes from the bottom plate towards the loading surface, and is spaced apart from the loading surface.

6. The electronic keyboard instrument according to claim 5,
wherein the bottom plate comprises multiple second adjustment legs,
wherein the multiple second adjustment legs are disposed at a central portion of the bottom plate in the aligning direction and on the first side and a second side in an extending direction of the multiple keys.

7. The electronic keyboard instrument according to claim 5,
wherein a clearance defined between the first adjustment leg and the loading surface is smaller than a clearance defined between the second adjustment leg and the loading surface.

8. The electronic keyboard instrument according to claim 1, further comprising:
a sound emitting device,
wherein in a plan view from above, the sound emitting device is disposed in a vicinity of a line segment connecting the multiple fixing legs together.
